(19) United States
(12) Patent Application Publication
(10) Pub. No.: US 2004/0145751 A1
(43) Pub. Date: Jul. 29, 2004

(54) Square wafer chuck with mirror

(76) Inventor: Michael B. Binnard, Belmont, CA (US)

Correspondence Address: RITTER, LANG & KAPLAN, 12930 SARATOGA AE. SUITE D1, SARATOGA, CA, 95070, US

(21) Appl. No.: 10/352,508

(22) Filed: Jan. 28, 2003

(51) Int. Cl. G01B 9/02

(52) U.S. Cl. 356/500

(57) ABSTRACT

Methods and apparatus for accurately measuring a position of a wafer chuck which holds a wafer are disclosed. According to one aspect of the present invention, a stage apparatus includes a sensing device and a chuck. The chuck substantially directly supports an object, and includes at least one side surface that is a mirrored surface. The sensing device is arranged to cooperate with the mirrored surface to measure a position of the chuck. In one embodiment, the mirrored surface is polished onto the chuck.

### BACKGROUND OF THE INVENTION

1. Field of Invention

The present invention relates generally to semiconductor processing equipment. More particularly, the present invention relates to a mechanism which reduces the effect of deformations on a wafer table and reduces vibrations within an overall stage apparatus.

2. Description of the Related Art

For precision instruments such as photolithography machines which are used in semiconductor processing, factors which affect the performance, e.g., accuracy, of the precision instrument generally must be dealt with and, insofar as possible, eliminated. When the performance of a precision instrument is adversely affected, as for example by vibrations or deformations, products formed using the precision instrument may be improperly formed and, hence, function improperly. For instance, a photolithography machine which is subjected to vibrations may cause an image projected by the photolithography machine to move, and, as a result, be aligned incorrectly on a projection surface such as a semiconductor wafer surface.

Scanning stages such as wafer scanning stages and reticle scanning stages are often used in semiconductor fabrication processes, and may be included in various photolithography and exposure apparatuses. Wafer scanning stages are generally used to position a semiconductor wafer such that portions of the wafer may be exposed as appropriate for masking or etching. Reticle scanning stages are generally used to accurately position a reticle or reticles for exposure over the semiconductor wafer. Patterns are generally resident on a reticle, which effectively serves as a mask or a negative for a wafer. When a reticle is positioned over a wafer as desired, a beam of light or a relatively broad beam of electrons may be collimated through a reduction lens, and provided to the reticle on which a thin metal pattern is placed. Portions of a light beam, for example, may be absorbed by the reticle while other portions pass through the reticle and are focused onto the wafer.

FIG. 1 is a diagrammatic representation of a photolithography apparatus which includes a stage apparatus. A photolithography apparatus 100 includes a stage apparatus 120 and a projection lens assembly 130. Stage apparatus 120 generally includes a base 122 which supports a coarse stage 124. Coarse stage 124 is generally arranged to enable a wafer 129, which is supported by a wafer chuck 128 that is a part of stage apparatus 120, to undergo coarse movements. A wafer table 126, or a fine stage, supports wafer chuck 128 and enables fine movements to be imparted on the wafer 129. Typically, wafer table 126 includes a fiducial mark (not shown) which is a reference mark that used to facilitate the positioning of wafer table 126 in a home position, as will be appreciated by those skilled in the art. The fiducial mark (not shown) also enables a reticle 140 to be aligned with wafer table 126 and, hence, a wafer 129 positioned on wafer chuck 128.

Knowledge of the position of wafer chuck 128 and, hence, the wafer 129 supported in wafer chuck 128 is generally needed to enable a reticle 140 to be properly aligned with respect to the wafer so that a pattern on reticle 140 may be projected through projection lens assembly 130 onto the wafer. In order to effectively enable the position of wafer chuck 128 to be measured, an interferometer 150 and a mirror 152 are used. Interferometer 150, which is supported by a projection lens assembly frame 154, sends a beam which reflects off of mirror 152, which is supported on wafer table 126, to detect the position of mirror 152 and, as a result, wafer table 126. Knowing the position of wafer table 126 typically enables the position of wafer chuck 128 and the wafer 129 supported on wafer chuck 128 to be determined, as wafer chuck 128 is mounted substantially on wafer table 126. Preferably, mirror 152 is positioned such that at least a portion of mirror 152 is substantially at the same height as the wafer 129 supported on wafer chuck 128.

While the use of interferometer 150 and mirror 152 is generally effective in enabling an approximate position of a wafer 129 to be determined, wafer table 126 may deform during operation. Such deformations may arise when vibrations are induced as a result of the translation, e.g., scanning, of wafer table 126 or coarse positioning stage 124. The deformation of wafer table 126 may cause the alignment of mirror 152 to be altered and, as a result, the measurements made using interferometer 150 may be inaccurate. In other words, there may be errors in measuring the position of the wafer 129 mounted on wafer chuck 128 when wafer table 126 deforms. As such, the accuracy of a photolithography process performed using apparatus 100 may be compromised. In an effort to prevent these problems, existing systems use wafer tables that are stiff and rigid, which causes the size of overall stage assemblies to be increased.

Vibrations which arise within apparatus 100 may cause errors associated with measuring positions, e.g., the position of the wafer 129 mounted on wafer chuck 128. Vibrations may give rise to static deformations, as mentioned above, which may bend wafer table 126 and cause the measurement of a position of a wafer 129 to be inaccurate when the position of mirror 152 is effectively moved with respect to wafer 129. Specifically, it is relatively difficult to effectively guarantee a constant relative position between mirror 152 and wafer chuck 128 due to vibrations and deformations within stage apparatus 120 without making wafer table 126 large and heavy.

In addition, there may be deformations of wafer table 126 which occur during assembly of apparatus 100, as for example when sensors are assembled to wafer table 126. When mirror 152 is attached to wafer table 126, such “assembly deformations” may distort mirror 152. Therefore, the position of wafer chuck 128 relative to mirror 152 may not be accurately known and, as a result, there may be an inherent error in measurements made using interferometer 150 even if there are no vibrations or vibration-induced deformations associated with wafer table 126.

Therefore, what is needed is a method and an apparatus which enables the position of a wafer within a wafer stage device to be accurately determined. That is, what is desired is a system which enables the measurement of a position of a wafer to be relatively unaffected by vibrations and deformations associated of a wafer stage device within which the wafer is mounted.

### SUMMARY OF THE INVENTION

The present invention relates to a chuck which includes a mirrored surface that may be used with a sensing device to measure a position associated with the chuck. According to one aspect of the present invention, a stage apparatus includes a sensing device and a chuck. The chuck substantially directly supports an object, and includes at least one side surface that is a mirrored surface. The sensing device is arranged to cooperate with the mirrored surface to measure a position of the chuck. In one embodiment, the mirrored surface is polished onto the chuck.

In another embodiment, the stage apparatus also includes a wafer table or a coarse positioning stage on which the chuck is positioned. In such an embodiment, the chuck may effectively be coupled to the wafer table by either a kinematic mount or a quasi-kinematic mount.

According to another aspect of the present invention, an interferometer system which may be used in a stage apparatus having a frame, a wafer chuck, and a wafer table includes an interferometer and a measuring mirror. The measuring mirror is positioned on a side face of the wafer chuck, and the interferometer and the measuring mirror are arranged to cooperate to measure a position of the wafer. In one embodiment, the measuring mirror is substantially directly polished onto the side face of the wafer chuck.

According to yet another aspect of the present invention, a method for measuring a position of a wafer positioned on a chuck of a stage device includes sending a laser from an interferometer that is arranged to come into contact with a mirrored side surface of the chuck, which also supports a wafer. The method also includes outputting information relating to the position of the chuck from the interferometer to a system controller after the reflected laser is received by the interferometer.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1 is a diagrammatic representation of a photolithography apparatus which includes a stage apparatus.

FIG. 2 is a diagrammatic representation of photolithography apparatus which includes a stage apparatus with a wafer chuck which includes mirrored surface in accordance with an embodiment of the present invention.

FIG. 3 is a diagrammatic perspective representation of a wafer chuck with more than one mirrored surface in accordance with an embodiment of the present invention.

FIG. 4a is a diagrammatic top view representation of a wafer chuck with two relatively flat sides in accordance with an embodiment of the present invention.

FIG. 4b is a diagrammatic top view representation of a wafer chuck with two relatively flat sides and a third curved side in accordance with an embodiment of the present invention.

FIG. 5 is a diagrammatic representation of a photolithography apparatus which includes a stage apparatus with a wafer chuck which includes a mirrored surface and is mounted on a kinematic mount in accordance with an embodiment of the present invention.

FIG. 6 is a diagrammatic representation of a photolithography apparatus in accordance with an embodiment of the present invention.

FIG. 7 is a process flow diagram which illustrates the steps associated with fabricating a semiconductor device in accordance with an embodiment of the present invention.

FIG. 8 is a process flow diagram which illustrates the steps associated with processing a wafer, i.e., step 1304 of FIG. 7, in accordance with an embodiment of the present invention.

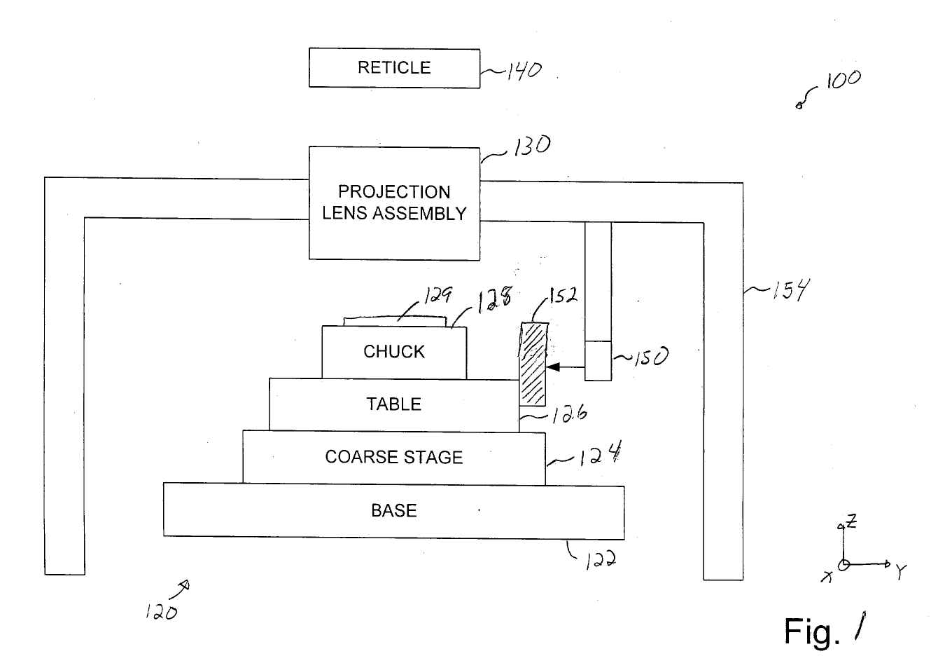

### DETAILED DESCRIPTION OF THE EMBODIMENTS

The ability to accurately measure the position of a wafer within a photolithography device is crucial to ensure that a photolithography process performed on the wafer is accurately performed. Often, measurements of position which pertain to the wafer may not be accurate due to deformations of a wafer table or vibrations within the photolithography device. As such, reducing the deformations of the wafer table and the vibrations within the photolithography device may improve measurements of wafer position and, hence, the accuracy of an overall photolithography process.

Allowing the position of a wafer to be substantially directly measured, as opposed to indirectly measures, may increase the accuracy with which measurements may be obtained. By way of example, rather than mounting a mirror for use with an interferometer on a wafer table which supports a wafer chuck that holds a wafer, the mirror may effectively be mounted directly on the wafer table. As a result, the position of the wafer chuck and, hence, the wafer supported by the wafer chuck, may be more directly measured. The position of the wafer is more directly measured because the mirror is more directly coupled to the wafer.

Directly coupling a mirror to a wafer chuck may include polishing the mirror directly onto the wafer chuck. When the mirror is not mounted directly on a wafer table, the wafer table may have less mass than a wafer table onto which a mirror is directly mounted. As a result, the wafer table may be smaller, and have fewer issues due to vibrations, thereby further increasing the accuracy with which the position of a wafer may be measured. Furthermore, the size of actuators to move the wafer table may be smaller and use less power.

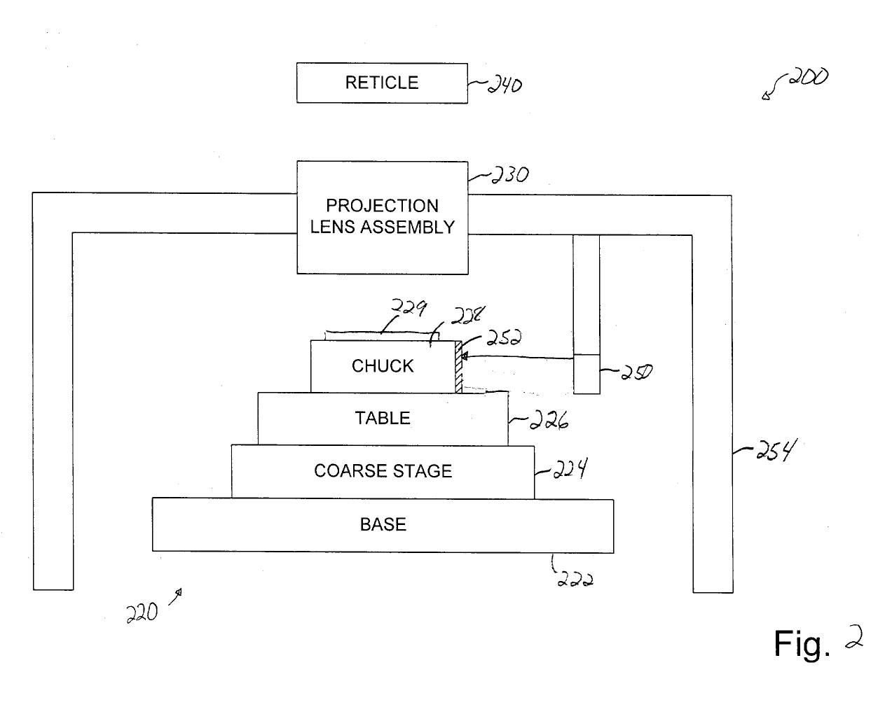

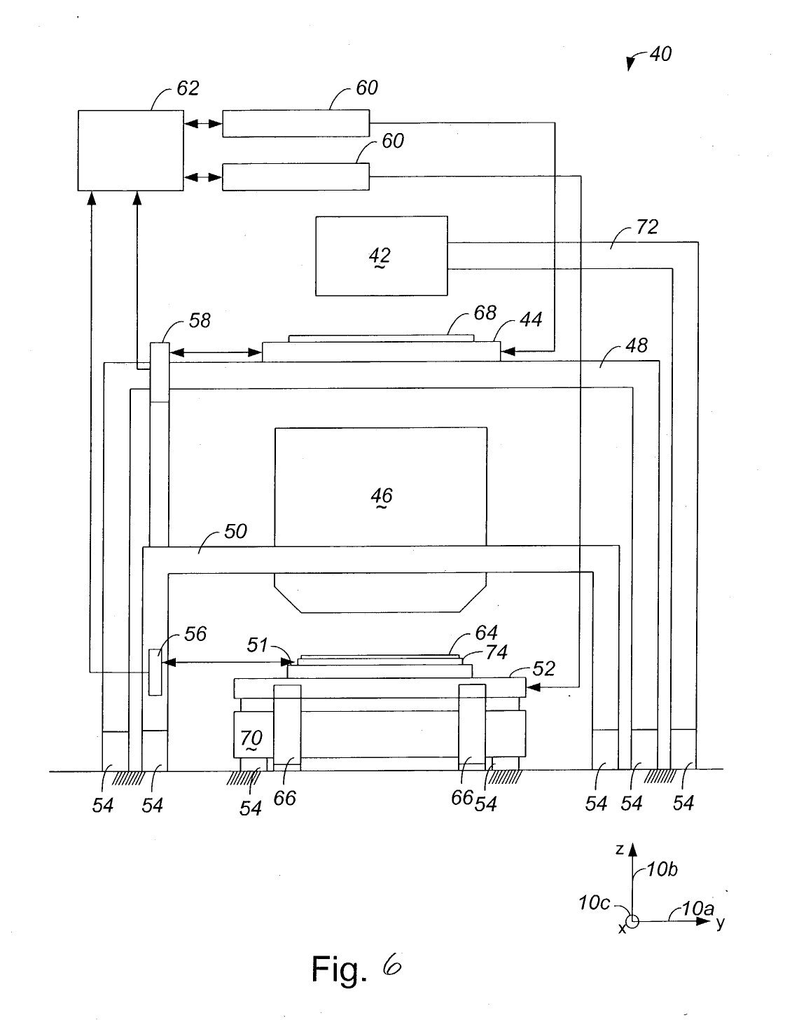

With reference to FIG. 2, one embodiment of a photolithography apparatus which includes a wafer chuck with at least one mirrored surface will be described. A photolithography apparatus 200 includes a stage apparatus 220 and a projection lens assembly 230 (projection optical system). Many features of photolithography apparatus 200 have not been shown for purposes of illustration. A photolithography apparatus which includes a wafer chuck with a mirrored surface will be discussed in more detail below with reference to FIG. 6.

Stage apparatus 220 includes a base 222 which supports a coarse positioning stage 224. Coarse positioning stage 224 is generally arranged to enable a wafer 229, that is positioned on a wafer chuck 228 of stage apparatus 220, to undergo coarse movements. A wafer table 226, or a fine positioning stage, supports wafer chuck 228, as for example through the use of a vacuum, and enables fine movements to be imparted on the wafer 229.

Wafer chuck 228 includes a mirror 252 which may either be polished substantially directly onto a side of wafer chuck 228 or attached to wafer chuck 228. Polishing mirror 252 substantially directly onto a side of wafer chuck 228 enables mirror 252 to be relatively lightweight. Mirror 252 is used with an interferometer 250, which may be supported on a projection lens assembly frame 254 which also supports a projection lens assembly 230, to measure a position of the wafer 229 supported on wafer table 226. Knowledge of the position of wafer chuck 228 and, hence, the wafer 229 positioned in and supported in wafer chuck 228 is generally needed to enable a reticle 240 to be properly aligned with respect to the wafer so that a pattern on reticle 240 may be projected through projection lens assembly 230 onto the wafer.

By directly coupling mirror 252 to wafer chuck 228 and not to wafer table 226, the position of the wafer 229 positioned on wafer chuck 228 may be more directly measured. In addition, coupling mirror 252 to wafer chuck 228 in lieu of wafer table 226 reduces the stiffness substantially required for wafer table 226. Hence, wafer table 226 may be formed to be less stiff, thinner, and lighter than a wafer table to which a mirror is directly coupled, as deformation requirements may be less rigid. Generally, small deformations of wafer table 226 will not have a significant effect on position measurements performed using interferometer 250 and mirror 252, since mirror is coupled directly to wafer chuck 228 and not to wafer table 226. As a result, wafer table 226 may be smaller, and stage apparatus may be subjected to fewer vibration problems.

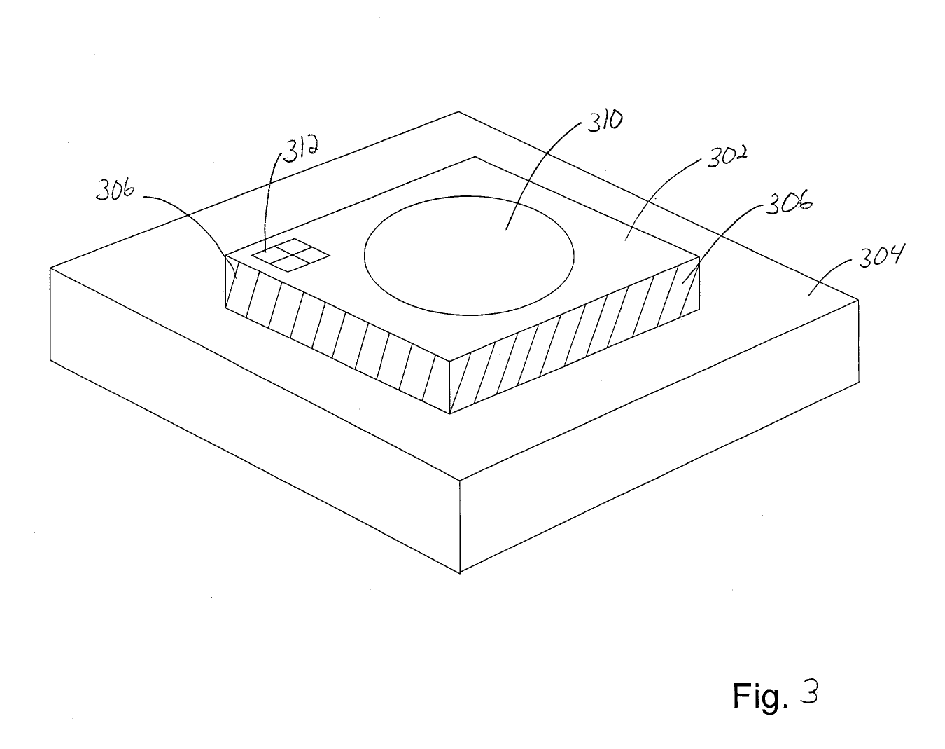

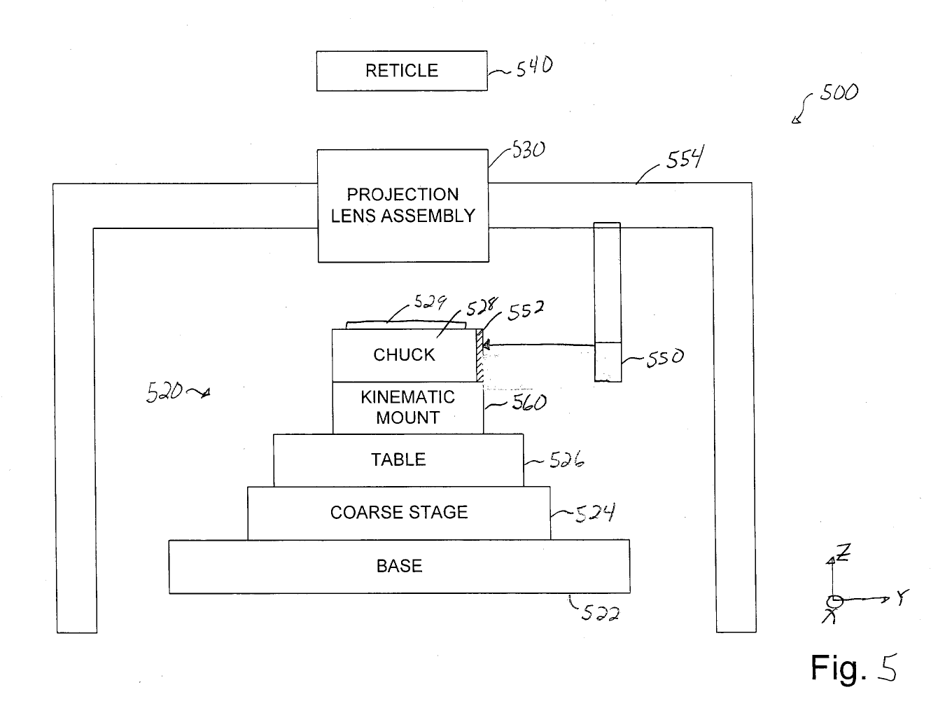

In general, the number of mirrors 252 on wafer chuck 228 may vary, e.g., depending upon the number of interferometers 250 which are used within apparatus 200. FIG. 3 is a diagrammatic perspective representation of a wafer chuck with more than one mirrored surface in accordance with an embodiment of the present invention. A wafer chuck 302, as shown, is mounted substantially directly on a wafer table 304. In one embodiment, a vacuum clamp (not shown) may be used to couple wafer chuck 302 to wafer table 304. It should be appreciated, however, that wafer chuck 302 may instead be substantially indirectly mounted on wafer table 304, as for example through the use of a kinematic mount or a quasi-kinematic mount, as will be discussed below with respect to FIG. 5. Wafer chuck 302 includes a wafer holding device (not shown) that holds wafer 226. In one embodiment, a vacuum clamp (not shown) may be used to hold wafer 229 to wafer chuck 302. However, the wafer holding device may use electrostatic force to hold wafer 229 to wafer chuck 302 instead of using vacuum.

Wafer chuck 302 includes mirrored surfaces 306. Mirrored surfaces 306, which may be ceramic mirrors that are polished substantially directly onto sides of wafer chuck 302, are arranged to be hit by interferometer lasers. Further, wafer chuck 302 may be the same material that is used in wafer table 304, like a ceramic with a low thermal expansion coefficient. However, instead of using the same material of wafer table 304, wafer chuck 302 may be another material that has a substantially low thermal expansion coefficient as wafer table 306. Since mirrored surfaces 306 are effectively directly coupled to wafer chuck 302 instead of wafer table 304, any deformation of wafer table 304 is less likely to have a significant effect on measurements of position which are made with respect to wafer table 304. In other words, since mirrored surfaces 306 are coupled to wafer chuck 302 which holds a wafer 310, measurements of the position of wafer 310 are made using mirrored surfaces 306 and, as a result, any deformation of wafer table 304 will generally have a relatively insignificant effect on the measurements of position, since the position if wafer 310 is measured off of wafer chuck 302 and not wafer table 304.

A fiducial mark 312, which is typically used to enable wafer 310 to be aligned in a home position or with a reticle, may be included on wafer chuck 302. Including fiducial mark 312 on wafer chuck 302 enables fiducial mark 312 to effectively be fixed relative to wafer 310 and mirrored surfaces 306. It should be appreciated that the configuration of fiducial mark 312 may vary widely.

As shown, wafer chuck 302 has a substantially polygonal footprint. Specifically, in the described embodiment, wafer chuck 302 is substantially rectangular such that wafer chuck 302 has a substantially rectangular footprint. Typically, two side surfaces of wafer chuck 302 are mirrored surfaces 306, although all four side surfaces of wafer chuck 302 may be mirrored surfaces 306. In order to enable an interferometer to accurately measure a position of wafer 310 using mirrored surfaces 306, mirrored surfaces 306 are generally formed as relatively flat surfaces. As a result, each surface of wafer chuck 302 that is a mirrored surface 306 is generally relatively flat or planar.

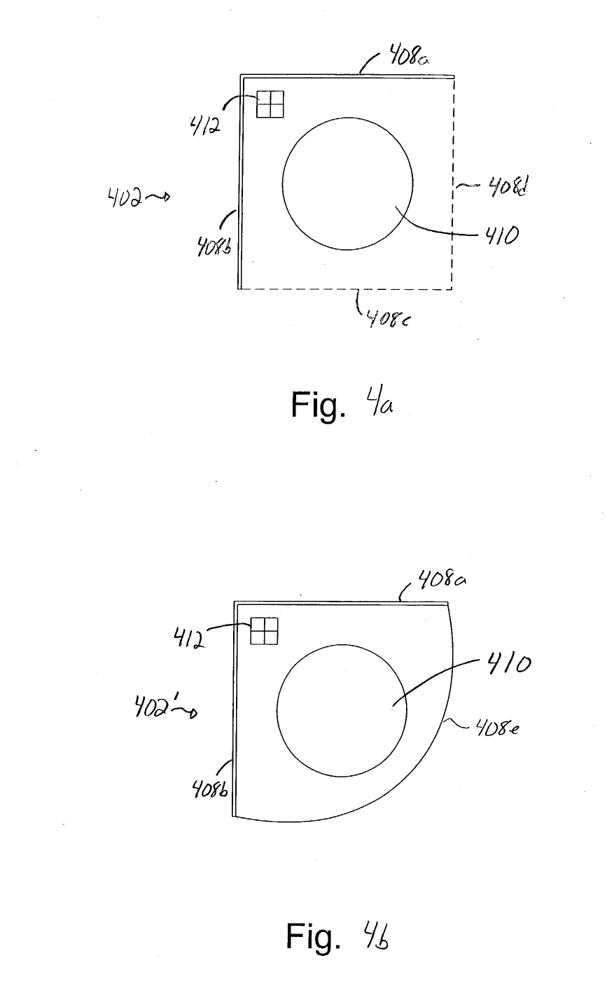

FIG. 4a is a diagrammatic top view representation of a wafer chuck with two relatively flat or planar sides in accordance with an embodiment of the present invention. A wafer chuck 402, which is arranged to hold a wafer 410, includes mirrored sides 408a, 408b or faces that, in one embodiment, have mirrors polished substantially directly onto wafer chuck 402. Mirrored sides 408a, 408b may for an approximately ninety degree angle, although the angle between mirrored sides 408a, 408b may vary. Wafer chuck 402 also includes a fiducial mark 412 which is arranged substantially near a corner of wafer chuck 402 between mirrored sides 408a, 408b. It should be appreciated, however, that fiducial mark 412 may generally be located substantially anywhere on a top surface of wafer chuck 402.

Sides 408c, 408d of wafer chuck 402 may generally be of substantially any suitable shape, if sides 408c, 408d are not mirrored surfaces which are used by interferometers for measurement purposes. As shown, sides 408c, 408d may be flat such that wafer chuck 402 has a substantially square shape or, more specifically, outline. However, when sides 408c, 408d are not mirrored surfaces which are used by interferometers for measurement purposes, sides 408c, 408d may be curved. As shown in FIG. 4b, in lieu of having relatively distinct sides 408c, 408d, a wafer chuck 402′ may have a substantially single side 408e. Single side 408e is curved, and cooperates with mirrored sides 408a, 408b to reduce the surface area of wafer chuck 402′ as compared to wafer chuck 402 of FIG. 4a. Reducing the surface area of wafer chuck 402′ typically enables the mass of wafer chuck 402′ to be reduced. As a result, issues relating to vibrations within an overall stage apparatus that includes wafer chuck 402′ may be reduced.

In order to isolate a wafer chuck from deformations caused by wafer table actuators or the assembling of parts, e.g., sensors, to the wafer table, a kinematic mount or a quasi-kinematic mount may be used to effectively mount a wafer chuck to a wafer table in lieu of a vacuum clamp, for example. A kinematic mount or support supports a wafer chuck with exactly six constraints, whereas a quasi-kinematic mount approximately supports a wafer chuck with six constraints, but is slightly over-constrained. Kinematic mounts and quasi-kinematic mounts which may be suitable for use with a wafer chuck such as a wafer chuck which includes at least one mirrored surface are described in co-pending U.S. patent application Ser. No. 09/997,553, filed Nov. 29, 2001, which is incorporated herein by reference in its entirety.

The use of a kinematic mount or a quasi-kinematic mount enables the coupling between a wafer chuck and a wafer table to be less rigidly coupled than when the wafer chuck and the wafer table are coupled using a vacuum clamp. As a result, deformations of the wafer table are less likely to have an effect on the wafer chuck when the wafer chuck is supported on the wafer table using a kinematic mount or a quasi-kinematic mount. FIG. 5 is a diagrammatic representation of a photolithography apparatus which includes a stage apparatus with a wafer chuck which includes a mirrored surface and is mounted on a kinematic mount in accordance with an embodiment of the present invention. A photolithography apparatus 500 includes a stage apparatus 520 and a projection lens assembly 530. For ease of illustration, various features of photolithography apparatus 500 have not been shown. Stage apparatus 520 includes a base 522 which supports a coarse positioning stage 524 which is generally arranged to enable a wafer (not shown) positioned on a wafer chuck 528 to undergo coarse movements. A kinematic mount or a quasi-kinematic mount 560 is positioned on wafer table 526, and supports wafer chuck 528 that has a mirror 552 either polished on its side or attached to its side. Wafer table 526 enables fine movements to be imparted on the wafer 529. Mirror 552 is typically used with an interferometer 550, which may be supported on a projection lens assembly 530 to measure a position of wafer 529 supported on wafer table 526 (wafer chuck 528). Knowledge of the position of wafer chuck 528 and, hence, wafer 529 positioned in and supported in wafer chuck 528 is generally needed to enable a reticle 540 to be properly aligned with respect to wafer 529 such that a pattern on reticle 540 may be projected through projection lens assembly 530 onto wafer 529.

With reference to FIG. 6, a photolithography apparatus which may include wafer chuck onto which a mirror has been polished will be described in accordance with an embodiment of the present invention. A photolithography apparatus (exposure apparatus) 40 includes a wafer positioning stage 52 that may be driven by linear motors or by a planar motor (not shown), as well as a wafer table 51 that is magnetically coupled to wafer positioning stage 52 by utilizing substantially any suitable actuator such as an EI-core actuator, e.g., an EI-core actuator with a top coil and a bottom coil which are substantially independently controlled. The motor or motors which drive wafer positioning stage 52 generally use electromagnetic force generated by magnets and corresponding armature coils arranged in two dimensions. A wafer 64 is held in place on a wafer holder or chuck 74 which is coupled either substantially directly to or indirectly, e.g., through a quasi-kinematic mount, to wafer table 5 1. Wafer positioning stage 52 and wafer table 51 are arranged to move in multiple degrees of freedom, e.g., between two to six degrees of freedom, under the control of a control unit 60 and a system controller 62. The movement of wafer positioning stage 52 allows wafer 64 to be positioned at a desired position and orientation relative to a projection optical system 46.

Wafer table 51 may be levitated in a z-direction 10b by any number of voice coil motors (not shown), e.g., three voice coil motors. In the described embodiment, at least three electro-magnetic actuators, e.g., EI-core actuators, (not shown) couple and move wafer table 51 along a y-axis 10a. The motor array of wafer positioning stage 52 is typically supported by a base 70. Base 70 is supported to a ground via isolators 54. Reaction forces generated by motion of wafer positioning stage 52 may be mechanically released to a ground surface through a frame 66. Reaction forces may be released to the floor or ground through a VCM or voice coil motor (not shown) that is substantially in contact with reaction frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground directly or via isolators 54. Illumination system 42 includes an illumination source, and is arranged to project a radiant energy, e.g., light, through a mask pattern on a reticle 68 that is supported by and scanned using a reticle stage 44 which includes a coarse stage and a fine stage. The radiant energy is focused through projection optical system 46, which is supported on a projection optics frame 50 and may be supported on the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer chuck 74 onto which a mirrored surface has been polished. Interferometer 56 outputs information on the position of wafer chuck 74 to system controller 62. In one embodiment, wafer table 51 has a force damper which reduces vibrations associated with wafer table 51 such that interferometer 56 may more accurately detect the position of wafer chuck 74. A second interferometer 58 is supported on optics frame 46, and detects the position of reticle stage 44 which supports reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer positioning stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes wafer 64 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 so that the next field of semiconductor wafer 64 is brought into position relative to illumination system 42, reticle 68, and projection optical system 46 for exposure. Following this process, the images on reticle 68 may be sequentially exposed onto the next field of wafer 64.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F₂-type laser (157 nm). Alternatively, illumination system 42 may also use charged particle beams such as x-ray and electron beams. For instance, in the case where an electron beam is used, thermionic emission type lanthanum hexaboride (LaB₆) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser is used, glass materials such as quartz and fluorite that transmit far ultra-violet rays is preferably used. When either an F₂-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan. Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

Further, in photolithography systems, when linear motors. (see U.S. Pat. Nos. 5,623,853 or 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

Isolaters such as isolators 54 may generally be associated with an active vibration isolation system (AVIS). An AVIS generally controls vibrations associated with forces, i.e., vibrational forces, which are experienced by a stage assembly or, more generally, by a photolithography machine such as photolithography apparatus 40 which includes a stage assembly.

A photolithography system according to the above-described embodiments, e.g., a photolithography apparatus which may include a wafer chuck with at least one mirrored surface, may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

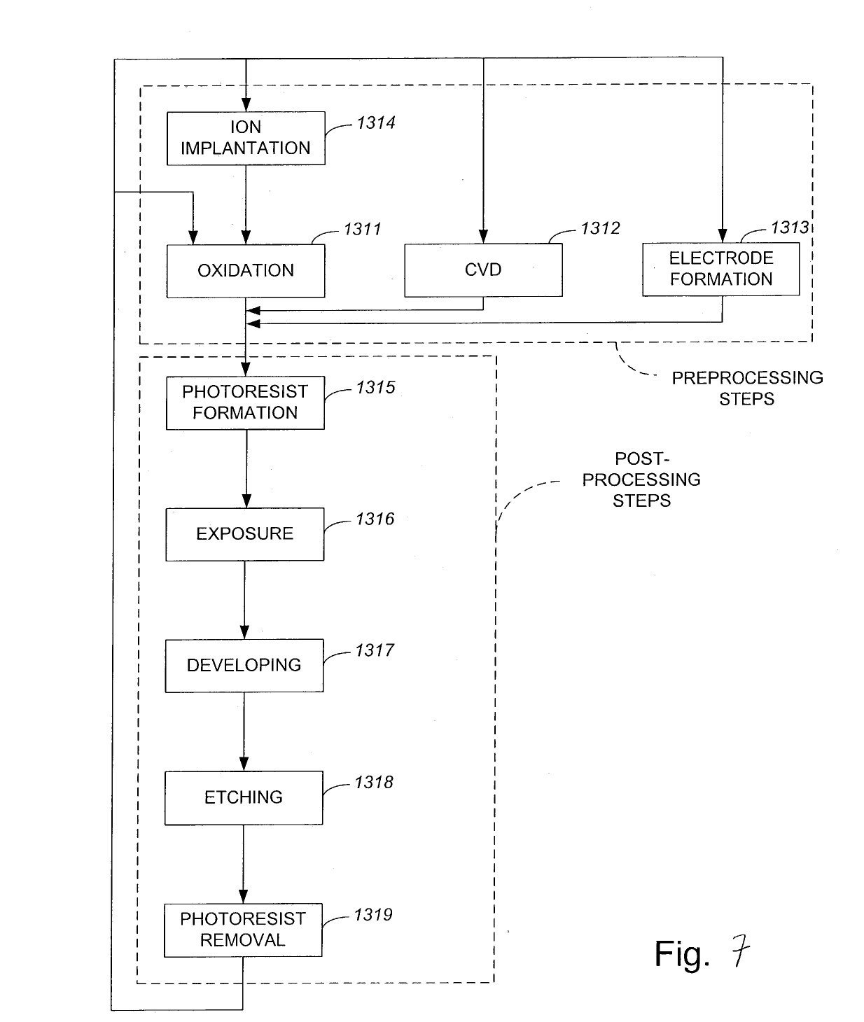

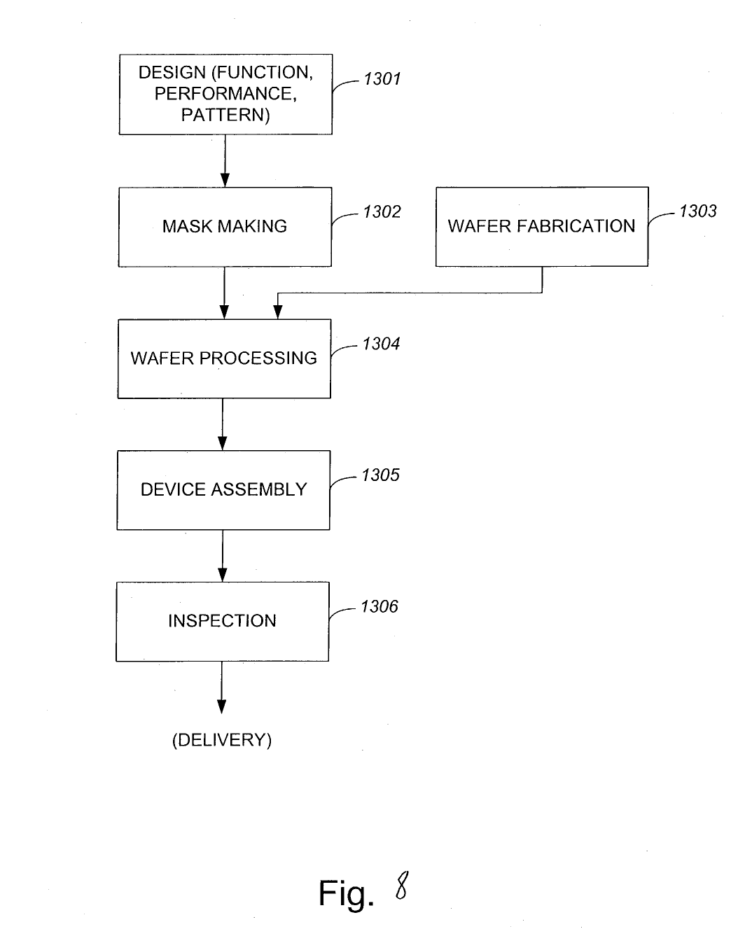

Further, semiconductor devices may be fabricated using systems described above, as will be discussed with reference to FIG. 7. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system. One process of exposing a mask pattern onto a wafer will be described below with respect to FIG. 8. In step 1305, the semiconductor device is assembled. The assembly of the semiconductor device generally includes, but is not limited to, wafer dicing processes, bonding processes, and packaging processes. Finally, the completed device is inspected in step 1306.

FIG. 8 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1317. Once the exposed wafer is developed, parts other than residual photoresist, e.g., the exposed material surface, may be removed by etching. Finally, in step 1319, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, although side surfaces of a wafer chuck have been described as being mirrored surfaces, the side surfaces may generally be substantially any reflective surfaces. That is, the side surfaces of a wafer chuck may be substantially any type of reflective surfaces which are suitable for use in cooperation with an interferometer or other similar sensing device to measure a position of the wafer chuck.

The use of a mirror polished directly onto a wafer chuck has generally been described as improving measurements performed on wafers or substrates within a wafer stage apparatus. It should be appreciated, however, that a mirror may be polished substantially directly onto any surface which on which measurements are made. For instance, a mirror may be polished onto a reticle holder which supports a reticle, and used in conjunction with an interferometer to measure the position of the reticle holder and, hence, the reticle. Therefore, the present examples are to be considered as illustrative and not restrictive, and the invention is not to be limited to the details given herein, but may be modified within the scope of the appended claims.

What is claimed is:

1. A stage apparatus comprising:
a sensing device; and
a chuck, the chuck being arranged to substantially directly support an object, the chuck including at least one side surface, the at least one side surface being a mirrored surface, wherein the sensing device is arranged to cooperate with the mirrored surface to measure a position of the chuck.

2. The stage apparatus of claim 1 wherein the mirrored surface is substantially polished onto the chuck.

3. The stage apparatus of claim 1 further including:
a wafer table, wherein the chuck is positioned substantially atop the wafer table.

4. The stage apparatus of claim 3 further including:
a kinematic mount, the kinematic mount being arranged to substantially couple the chuck to the wafer table.

5. The stage apparatus of claim 3 further including:
a quasi-kinematic mount, the quasi-kinematic mount being arranged to substantially couple the chuck to the wafer table.

6. The stage apparatus of claim 1 wherein the sensing device is an interferometer.

7. The stage apparatus of claim 1 wherein the object is a wafer.

8. The stage apparatus of claim 1 wherein the object is a reticle.

9. The stage apparatus of claim 1 wherein the chuck further includes a fiducial mark, the fiducial mark being positioned on a top surface of the chuck.

10. The stage apparatus of claim 1 wherein the chuck has a substantially polygonal footprint.

11. The stage apparatus of claim 1 wherein the mirrored surface is substantially flat.

12. An exposure apparatus comprising the stage apparatus of claim 1.

13. A device manufactured with the exposure apparatus of claim 12.

14. A wafer on which an image has been formed by the exposure apparatus of claim 12.

15. An interferometer system for use in a stage apparatus, the stage apparatus including a frame, a wafer chuck, and a wafer table, the wafer chuck being arranged to substantially directly support a wafer, the wafer chuck being supported on the wafer table, the interferometer system comprising:
an interferometer; and
a measuring mirror, the measuring mirror being positioned on a side face of the wafer chuck, wherein the interferometer and the measuring mirror are arranged to measure a position of the wafer.

16. The interferometer system of claim 15 wherein the measuring mirror is substantially directly polished onto the side face of the wafer chuck.

17. The interferometer system of claim 15 wherein the interferometer is arranged to send a laser to the measuring mirror.

18. The interferometer system of claim 15 wherein a kinematic mount is arranged to substantially couple the wafer chuck to the wafer table.

19. The interferometer system of claim 15 wherein a quasi-kinematic mount is arranged to substantially couple the wafer chuck to the wafer table.

20. An exposure apparatus comprising the interferometer system of claim 15.

21. A device manufactured with the exposure apparatus of claim 20.

22. A wafer on which an image has been formed by the exposure apparatus of claim 20.

23. A chuck, the chuck being arranged to be used within a stage apparatus, the chuck comprising:
a first side surface, the first side surface being a reflective surface, wherein the first side surface is substantially flat; and
a mechanism, the mechanism being arranged to hold an object substantially in place.

24. The chuck of claim 23 wherein the reflective surface is a mirrored surface.

25. The chuck of claim 24 further including:
a second side surface, the second side surface being substantially flat.

26. The chuck of claim 25 wherein the second side surface is a mirrored surface.

27. The chuck of claim 24 further including:
a top surface; and
a fiducial mark, the fiducial mark being arranged on the top surface.

28. The chuck of claim 24 wherein the object is one of a wafer substrate or a reticle.

29. The chuck of claim 22 further including:
a bottom surface, the bottom surface being arranged to be coupled to a kinematic mount.

30. The chuck of claim 22 further including:
a bottom surface, the bottom surface being arranged to be coupled to a quasi-kinematic mount.

31. An exposure apparatus comprising the chuck of claim 24.

32. A device manufactured with the exposure apparatus of claim 31.

33. A wafer on which an image has been formed by the exposure apparatus of claim 31, wherein the wafer is the object supported by the mechanism.

34. A method for measuring a position of an object positioned on a chuck of a stage device, the chuck being arranged to substantially directly hold the object, the chuck having at least one mirrored side surface, the method comprising:
sending a laser from an interferometer, the laser being arranged to come into contact with the at least one mirrored side surface; and
outputting information relating to the position of the chuck from the interferometer to a system controller at some time after sending the laser.

35. The method of claim 34 further including:
receiving a reflected laser on the interferometer, wherein outputting the information relating to the position of the chuck from the interferometer to the system controller at some time after sending the laser includes outputting the information after receiving the reflected laser.

36. A method for operating an exposure apparatus comprising the method for measuring of claim 34.

37. A method for making an object including at least a photolithography process, wherein the photolithography process utilizes the method of operating an exposure apparatus of claim 36.

38. A method for making a wafer utilizing the method of operating an exposure apparatus of claim 36.

39. A chuck, the chuck being arranged to be used within a stage apparatus, the chuck comprising:
a mechanism, the mechanism being arranged to hold an object substantially in place; and
a top surface, the top surface including a fiducial mark, the fiducial mark being arranged to facilitate the positioning of the chuck.

40. The chuck of claim 39 wherein the object is one of a wafer substrate or a reticle.

41. An exposure apparatus comprising the chuck of claim 39.

42. A device manufactured with the exposure apparatus of claim 41.

43. A wafer on which an image has been formed by the exposure apparatus of claim 41, wherein the wafer is the object supported by the mechanism.
